(19) United States
(12) Patent Application Publication
(10) Pub. No.: US 2004/0122560 A1
(43) Pub. Date: Jun. 24, 2004

(54) Virtual conservation devices

(76) Inventor: Douglas Hart, Toronto (CA)

Correspondence Address: SHOEMAKER AND MATTARE, LTD., Suite 1203, Crystal Plaza Building 1, 2001 Jefferson Davis Highway, Arlington, VA, 22202, US

(21) Appl. No.: 09/794,955

(22) Filed: Feb. 28, 2001

Related U.S. Application Data
(60) Provisional application No. 60/185,466, filed on Feb. 28, 2000.

(51) Int. Cl. G05B 15/00

(52) U.S. Cl. 700/275

(57) ABSTRACT

There is provided an internet-based method of controlling a mechanical system to which a resource such as energy or water is fed along at least one conduit The resource is consumed variably with respect 1o time and ambient conditions, whereby as the performance of the system changes, the pattern of consumption is altered. The method includes a) monitoring the pattern of consumption of the resource and ambient conditions, using the internet, b) through analysts of the pattern of resource use with respect to time at a central server, determining when a significant performance deficiency occurs; and c) altering the performance of the system.

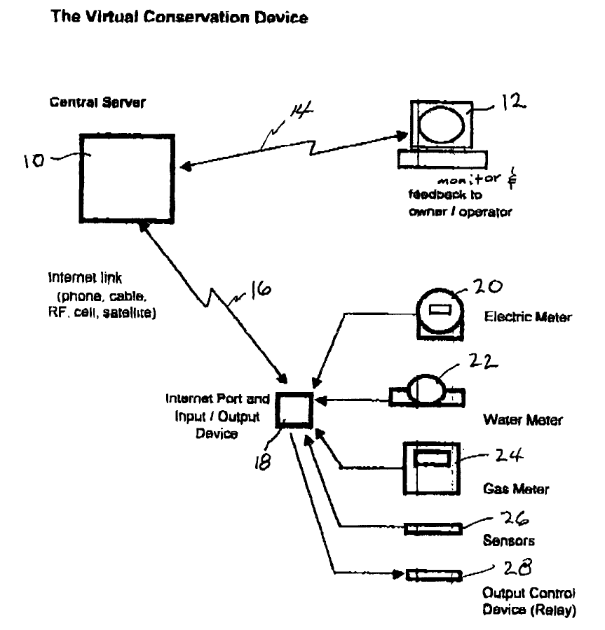

A family of virtual energy and water conservation devices have been developed which use the internet and require minimal on-site hardware. They offer the opportunity for wide implementation of energy and water conservation at very low cost.

The system monitors the pattern of consumption of resources with respect to time, and through mathematical algorithms embedded in a central server, provides the feedback and control needed for energy and water conservation. The patterns of consumption are used to characterize the systems themselves, and provide a feedback system that can improve the performance of the system being measured.

### BACKGROUND OF THE INVENTION

In U.S. Pat. No. 5,193,212 (Canadian Patent Nos. 2065684 and 2125553) issued to the applicant, a dryer device is described which senses the ON-OFF pattern of a dryer heater, and through a mathematical algorithm which analyses the consumption of heating fuel with respect to time, determines the point of dryness of the load, and more accurately terminates the drying cycle, saving valuable energy.

Similarly, in Canadian Patent No. 1,240,766, a thermostat device is described which senses the ON-OFF pattern of the heating system of a building with respect to time, and through a mathematical algorithm, combined with the sensing of outside temperature, calculates the efficiency of the building and heating plant, providing valuable feedback to the building owner for energy conservation.

A virtual system has now been developed which uses the internet to provide these feedback functions, with minimal requirement for physical devices on sale. The system recognizes the pattern of consumption of resources with respect to time and through the use of algorithms embedded in a central server, can characterize and improve the control of the mechanical systems themselves, saving valuable energy and resources on a wide spread basis.

For example, the control function of the dryer device described in U.S. Pat. No. 5,193,212 can be provided though real time sensing of the electric energy consumption with respect to time, and through the use of a control signal, provide the identical functionality of the dryer device through a central server, with little requirement for on-site hardware or intelligence.

Similarly, the algorithms formerly incorporated into the thermostat in Canadian Patent No. 1,240,766 can now be embedded off-site and this feedback provided over the internet for the improvement of building performance

Similar systems have also been developed by the applicant for the use of water. Algorithms which analyse the water consumption pattern with respect to time can be used to characterize the water leakage levels in multi-residential buildings, and by pattern recognition, identify problems with water distribution and appliances

It should be noted that this system can also be applied to refrigerators, toilets, water heaters, air conditioners, and indeed any appliances That use resources, either on the single family level, or multi-residential buildings, or commercial systems In a home, the sensing of the energy and water consumption with respect to time can identify the operational pattern of a refrigerator, toilet or dryer for example, and through mathematical algorithms, the performance can be analysed In a bulk, multi-residential setting, the system can identify the overall performance of these systems, identifying water leakage, air conditioning problems, space heating performance, and domestic water heating efficiency.

In some cases, a control function can be provided (such as with the dryer device). For example, an internet driven signal from the server can control a relay on the dryer circuit that stops the dryer when the clothes are ready. In other cases a control function is not required (such as with the thermostat device). Here, the system provides feedback function and recommends action, such as performance alterations, energy or water improvements, or replacement or servicing of poorly functioning equipment. The feedback is provided over the internet to the owner/operator.

In cases where control is involved, a real internet time connection may be important. In other cases, where the system is used to analyse the performance of the device and recommend action such as in the thermostat patent, a real time connection is not necessary.

### GENERAL DESCRIPTION OF THE INVENTION

More specifically, this invention provides an internet-based method of controlling a mechanical system to which a resource (such as energy or water) is fed along at least one conduit, the system having a variable consumption of the resource with respect to time and ambient conditions, such that as the performance of the system changes, the pattern of consumption is altered; the method comprising the following steps:

a) monitoring the said pattern of consumption of the resource and ambient conditions using the internet,

b) through analysis of the pattern of resource use with respect to time at a central server, determining when a significant performance deficiency occurs, and

c) altering the performance of the system.

### GENERAL DESCRIPTION OF THE DRAWING

In the drawing, a central server 10 communicates with a monitor 12 which is also capable of feedback to the owner. Communication in both directions is done by way of the Internet (symbolized by the zig-zag, two-headed line 14).

The central server 10 is also in communication, through the Internet (the line 16), with the internet port and input/output device 18. The device 18 receives data from an electric meter 20, from a water meter 22, from a gas meter 24, and from various additional sensors 26 An output control device 28 receives a signal from the Internet port 18.

Description of Numerical Algorithm for Dryer Control

In this embodiment, the characteristic ON-OFF pattern of an electric clothes dryer is recognized by the internet port on site. The following numerical algorithm is used to determine the time of dryness of the laundry, and terminate the cycle This system provides a more accurate termination than conventional systems, saving significant energy (typically 20% of the total drying energy).

As a dryer dries laundry, the dryer heater cycles ON and OFF between thermostatic limits. The data is sensed as ON and OFF times by the internet port which is connected to the central electrical meter of the house. A relay is used on the dryer circuit on site to terminate the cycle when the clothes are ready.

The variable to be predicted is called AONT which is the accumulated ON time of the dryer heated until the desired level of laundry dryness is reached Two analyses were performed in the development of this algorithm. Both these analyses occur during the first part of the drying cycle, and these are used to predict when dryness occurs.

The first analysis was based on the first 10 minutes of time, or the first 3 ON-OFF cycles, whichever takes longer. For the i-th cycle in this period, the difference D(i)=(on time)−(off time) is computed. The mean IYBI of these differences is then computed. Then a straight line 1B1=(SLB1)t is fitted to the points (t1, D(i)) where ti is the total time from 0 to the beginning of the i-th cycle. IB1 is the intercept of the line, and SLB1is the slope. The D(i) were also transformed to Yi-log(D(i)−min{D(i)}+1) and a second straight line LIl+(LSLI)i was fitted to the points (ii. YJ). Lll is the intercept of this line and LSLI is the slope Several other variables were also created, namely Ll1S=LII*LIl, IB1S=IB1*IBI, and IBSLB1=1BI*SLBl Altogether, this produces eight predictor variables {IYBI, IBI, SLBl, Lll, ISLI, IBSLBI, LIIS and IBIS} that were then used as a basis for predicting AONT, using the input of the times of the heater ON-OFF cycles.

The next step in the analysis was to construct a discriminator that assigns a load of laundry to one of two groups. Group=0 indicates delicate and permanent press type loads, and Group=1 indicates the remaining types of loads. The discriminator was constructed by first fitting an equation Y=Bo+Σ_{=.7}Bx, to the files where Y=0 if the load was in group 0 and Y=1 otherwise. The x were 7 of the predictor variables described in the previous paragraph. The variable LSLI was not used. A stepwise regression analysis was then carried out to determine a “best” subset of the predictors for predicting Y. This led to using the variables {JIYB1, LII, SLBI, IB1, IBSLB1} in the discriminator and dropping the others {LIIS and IBIS)}. From this, the numerical values of the Bi were obtained and these values together with the values of the x, for a new load are used to assign the load to one of the 2 groups, 0 or 1.

A predictor was then constructed for each group by first fitting the equation AONT=Bo+Σ_{=.7}Bx using the 7 predictor variables described above (again not including LSLl). A stepwise regression was then carried out that led to using the 3 variables {LIlS, LI1, IBSLBI} for prediction with group 0 and the 2 variables {IYBI, LI1S} for prediction with group I. Hence the groups are indeed different. This model does an excellent job of prediction as the R² between the predicted values of AONT and the actual values of AONT was 95% on a diverse sample of 108 dryer data files.

As a second step in the development of this method, the analysis was continued to include the next 10 minutes of time beyond the time limit of the first predictor. More variables were added by fitting a line 182=(SLB2)t to the (ti, Yi) for the period. The variables LI2 and LSL2 were then transformed to L12=LII1−LI2 and LSL2=LSLI−LSL2. A new derived variable was also added, namely IBSLB2=IB2*SLB2. The data used for fitting these new variables did not include those files that had already been terminated during this period using the first predictor The equation AONT=Bo+Σ_{=.7}Bx, was then fit using stepwise regression where the II predictor variables were: IYBI, IB1, SLB1, Lil, IBSLB, IIB1S, IB2, SLB2. L12, LSL2 and IBSLB2. This led to selecting the variables {IYBI, Lll, L12} for group 0 and {IYB1, LI2, SLB1, LSL2, IBSLB2} for group 1 The R² generated by this second model was even higher, at 97%.

To apply this approach, the B values are stored in the server memory, and the variables described above are calculated as information about the dryer heater current (the ON-OFF status) is received through the internet port. The first predictor calculated by the server divides the load into one or the other of the laundry groups, and then applies the appropriate predictor calculations to determine the best time to shut down the cycle.

At the point of dryness, a control relay is activated on site by the server, terminating the dryer cycle. In the case of an electric dryer, a short (10 second) termination is sufficient to permanently stop the cycle because dryers must be manually reset to restart the drying cycle.

This approach has the advantage that in the development of the B values, the variable AONT can be set for different moisture targets thus allowing the correlation or selection of different moisture levels in the laundry load.

While one embodiment of this invention has been illustrated in the accompanying drawing and described hereinabove, it will be evident to those skilled in the art that changes and modifications may be made thereto, without departing from the essence of this invention, as set forth in the appended claims.

The embodiments of the invention in which an exclusive property or privilege is claimed are defined as follows:

1. An internet-based method of controlling a mechanical system to which a resource is fed along at least one conduit, the system having a variable consumption of the resource with respect to time and ambient conditions, such that as the performance of the system changes, the pattern of consumption is altered, the method comprising the following steps:
a) monitoring the said pattern of consumption of the resource and ambient conditions, using the internet;
b) through analysis of the pattern of resource use with respect to time at a central server, determining when a significant performance deficiency occurs; and
c) altering the performance of the system.

2. The method claimed in claim 1 in which the mechanical system is a clothes dryer, and an analysis of the consumption of energy with respect to time is used to more accurately determine the point of termination of the drying cycle, thereby improving the performance of the clothes dryer.

3. The method claimed in claim 1 in which the mechanical system is the water supply system for a building, and through analysis of the pattern of consumption of water with respect to time, the performance of toilets, cooling towers, fountains faucets and fixtures can be determined and corrected.

4. The method claimed in claim 1 in which the mechanical system is the heating system for a building, the pattern of fuel consumption and ambient conditions being used to determine and correct the heating performance of the building and heating plant.

5. The method claimed in claim 1 in which the mechanical system is a cooling system, the pattern of fuel consumption and ambient conditions being used to determine and correct the cooling performance of the building and the cooling system.

6. The method claimed in claim 1 in which the mechanical system is a refrigerator and analysis of the pattern of electrical consumption with respect to time is used to determine and correct the performance of the refrigerator.

7. The method claimed in claim 1 in which the mechanical system is a water heater and analysis of the pattern of energy and water use with respect to time is used to determine and correct the performance of the water heater.

8. The method claimed in claim 1 in which the resource monitoring means is an internet connection to the utility meters of the building.

9. The method claimed in claim 1 in which the means of control is by the provision of data and analysis through the internet to building owners and operators to enable the correction or replacement of defective equipment.

10. The method claimed in claim 1 in which the means of control is by a relay or controller located at the building site, which is in internet communication with the central server.

11. The method claimed in claim 3 in which the daily pattern of water consumption in multi-unit residential buildings is analysed over a period of time to create an index, this index being the average minimum value of the water consumed over a period, divided by the average value for that same period, such index being used as an indicator of water performance for the building.

12. The method claimed in claim 4 in which the pattern of fuel consumption is taken over a given period where the ambient daily temperature on each day is below 10 C, pattern of fuel consumption is related mathematically to the water consumption and outside temperature pattern for the same period to create a dimensionless energy efficiency index which determines the performance of the building and its heating system.

13. The method claimed in claim 6 in which the pattern of electrical consumption of the refrigerator, can be identified by its characteristic ON-OFF pattern and through analysis of the energy use determine the efficiency of the refrigerator and recommend corrective action.
